(19) United States
(12) Patent Application Publication
(10) Pub. No.: US 2013/0097387 A1
(43) Pub. Date: Apr. 18, 2013

(54) MEMORY-BASED APPARATUS AND METHOD

(71) Applicant: The Board of Trustees of the Leland Stanford Juni, Palo Alto, CA (US)

(72) Inventors: Daniel Sanchez Martin, Cambridge, MA (US); Christoforos Kozyrakis, San Francisco, CA (US)

(73) Assignee: The Board of Trustees of the Leland Stanford Junior University, Palo Alto, CA (US)

(21) Appl. No.: 13/652,249

(22) Filed: Oct. 15, 2012

Related U.S. Application Data
(60) Provisional application No. 61/547,296, filed on Oct. 14, 2011.

(51) Int. Cl. G06F 12/08

(52) U.S. Cl. 711/129; 711/133; 711/E12.022; 711/E12.042

(57) ABSTRACT

Aspects of various embodiments are directed to memory circuits, such as cache memory circuits. In accordance with one or more embodiments, cache-access to data blocks in memory is controlled as follows. In response to a cache miss for a data block having an associated address on a memory access path, data is fetched for storage in the cache (and serving the request), while one or more additional lookups are executed to identify candidate locations to store data. An existing set of data is moved from a target location in the cache to one of the candidate locations, and the address of the one of the candidate locations is associated with the existing set of data. Data in this candidate location may, for example, thus be evicted. The fetched data is stored in the target location and the address of the target location is associated with the fetched data.

### FIELD

Aspects of various embodiments are directed to memory controller circuits, and to controlling cache memory access.

### BACKGROUND

The ever-increasing importance of main memory latency and bandwidth is pushing some computer systems to include data and/or instruction caches that are set associative. For multi-core chips and chip-multiprocessors (CMPs) that include tens or up to hundreds and thousands of cores, the limited bandwidth, high latency, and high energy of main memory accesses become an important limitation to scalability. To mitigate this bottleneck, CMPs rely on complex memory hierarchies with large and highly associative caches, which commonly take more than 50% of chip area and contribute significantly to static and dynamic power consumption.

An associative cache includes one or more ways. A way is a logical division of the entries in a cache into multiple identical groups. Each physical address in memory can be stored in a single block in each way of the cache. Associativity can be improved by increasing the number of ways. Higher associativity provides more flexibility in data placement in the cache, reduces conflicts misses, and allows utilization of limited cache capacity in the best possible manner, and reduces the frequency of accesses to main memory. However, higher associativity increases the hit access latency, the hit access energy, and the area of the cache, placing a stringent trade-off on cache design.

Another memory-related aspect that has been challenging to implement relates to the partitioning of cache memory. Partitioning restricts the placement of addresses accessed by a specific core or application to a subset of the entries in the cache. Partitioning reduces the interference between different applications. However, partitioning reduces the flexibility in data placement for each application and increases conflict misses. Various partitioning schemes are difficult to implement, are inefficient and costly.

Another memory-related aspect that has been challenging to implement relates to the directory structure used to maintain cache coherence in CMPs. The directory structure is a cache that tracks copies of a physical address across the multiple data and/or instruction caches in CMPs. A high capacity and high associativity directory reduces the number of main memory accesses. However, a high capacity and high associativity directory increases the hit access time, the hit access energy, and the area of the directory.

These and other matters have presented challenges to the implementation and management of cache memory, for a variety of applications.

### SUMMARY

Various example embodiments are directed to cache memory and cache memory controller circuits and their implementation.

According to an example embodiment, an apparatus and/or method involves a memory circuit having cache lines that store data blocks, and a controller circuit that control cache-access to the data blocks in the memory circuit as follows. In response to a cache miss for a data block having an associated address on a memory access path, data for storage in the cache is fetched while executing zero or more additional lookups to each way of the cache on the memory access path, such as by using two or more hash functions to identify a plurality of candidate locations. One of the plurality of candidate locations is selected to evict from the cache. One of the plurality of candidate locations is selected as the target location for the fetched data. The data from zero or more of the plurality of candidate locations is moved to other of the plurality of locations in order to vacate the target location. The fetched data is then stored in the target location, and the address of the target location is associated with the fetched data. Subsequent accesses to the fetched data are completed with a single lookup to each way of the cache.

In accordance with other example embodiments, the memory circuit is operated with a partitioned memory circuit region including isolated partitions with sizes specified in cache lines, and an un-partitioned memory circuit region configured and arranged to facilitate data replacement in the isolated partitions. These respective regions may, for example, be logical in that data blocks can be assigned as either being partitioned (managed) or un-partitioned (unmanaged). The controller circuit increases the size of the isolated partitions by converting space in the un-partitioned memory circuit region to additional isolated partition space, and decreases the size of the isolated partitions by converting space in the partitioned memory circuit region to space in the un-partitioned memory circuit region.

In another example embodiment, the controller circuit defines directory sharer tag data for processors sharing access to memory blocks using a variable number of directory tags as follows. For cache lines accessed by less than a threshold number of processors, a single directory tag is defined, which associates each cache line with the processor or processors that access the cache line. For each cache line accessed by a number of processors that is equal to or greater than the threshold number of processors, at least two directory tags are defined for each cache line. Each of the at least two directory tags associates the cache line with one or more of the processors that access the cache line. In some implementations, a single directory tag is converted to two or more tags as the number of sharers increases, or two or more tags are converted to fewer (or one) tag as the number of sharers decreases.

The above discussion/summary is not intended to describe each embodiment or every implementation of the present disclosure. The figures and detailed description that follow also exemplify various embodiments.

### DESCRIPTION OF THE FIGURES

Various example embodiments may be more completely understood in consideration of the following detailed description in connection with the accompanying drawings, in which:

FIG. 1 shows a memory controller and related memory circuits, in accordance with one or more example embodiments;

FIGS. 2A-2G show characteristics of memory access and control in accordance with one or more embodiments, in which

FIG. 2A shows an initial cache state and initial miss,

FIG. 2B shows hash values of first-level candidates for replacement,

FIG. 2C shows hash values for second-level candidates for replacement,

FIG. 2D shows three levels of replacement candidates with selection of one such candidate,

FIG. 2E shows relocations carried out to accommodate an incoming block,

FIG. 2F shows a cache state after replacement, and

FIG. 2G shows a timeline of requests and responses;

FIG. 3 shows an apparatus and approach involving partition control and related tag fields, in accordance with another example embodiment;

FIG. 4 shows a data flow diagram for cache access, in accordance with another example embodiment;

FIG. 5 shows a data flow diagram for demoting data, in accordance with another example embodiment; and

FIG. 6 shows a data flow diagram for setting a set point for determining the demotion of data, in accordance with another example embodiment.

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims.

### DETAILED DESCRIPTION

Aspects of the present disclosure are believed to be applicable to a variety of different types of apparatuses, systems and methods involving memory control and access, such as cache memory control and access. While not necessarily so limited, various aspects may be appreciated through a discussion of examples using this context.

Various example embodiments are directed to apparatuses and methods directed to controlling cache-access attempts to a memory circuit. Addresses are associated with data blocks stored in the memory circuit. For cache hits, data blocks corresponding to each hit are returned in response to a single lookup for an associated address on a memory access path. In response to a cache miss, data is fetched for storage in the cache while an additional lookup is executed on the memory access path to identify a plurality of candidate locations to store data. An existing set of data is moved from a target location in the cache to one of the plurality of candidate locations. The address of the one of the plurality of candidate locations is associated with the existing set of data, and the fetched data is stored in the target location with the address of the target location being associated with the fetched data.

In a more particular example embodiment, a memory circuit as above includes a partitioned memory circuit region including isolated partitions with sizes specified by cache lines, and an un-partitioned memory circuit region configured and arranged to facilitate data replacement in the isolated partitions. The size of the isolated partitions is increased by converting space in the un-partitioned memory circuit region to additional isolated partition space. Correspondingly, the size of the isolated partitions is decreased by converting space in the partitioned memory circuit region to space in the un-partitioned memory circuit region.

For information regarding details of other embodiments, experiments and applications that can be combined in varying degrees with the teachings herein, reference may be made to the teachings and references provided in Appendices A, B, C and D in the provisional patent document identified in the Application Data Sheet filed herewith, and which are fully incorporated herein by reference. Reference may also be made to related publications, including “The ZCache: Decoupling Ways and Associativity,” 43rd Annual IEEE/ACM International Symposium on Microarchitecture (MICRO-43), pp. 187-198 (2010); D. Sanchez and C. Kozyrakis, “Vantage: Scalable and Efficient Fine-Grain Cache Partitioning,” In Proc. of the 38th ISCA, CA (2011); D. Sanchez and C. Kozyrakis, “SCD: A Scalable Coherence Directory with Flexible Sharer Set Encoding,” High Performance Computer Architecture (HPCA), 2012 IEEE 18th International Symposium, pp. 1-12, (Feb. 25-29, 2012); and D. Sanchez and C. Kozyrakis, “Scalable and Efficient Fine-Grained Cache Partitioning with Vantage,” Micro, IEEE, Vol. 32, No. 3, pp. 26-37 (May/June 2012), all of which are fully incorporated herein by reference.

Aspects of the present disclosure have application with and are directed to memory apparatuses and methods. Certain aspects are directed to cache-based memory, such as described in the Appendices of the above-referenced provisional patent document, and related publications referenced above, and which may be implemented to facilitate associativity that may be higher than a physical number of ways in a particular cache (e.g., a 64-associative cache with 4 ways). Such approaches may involve skew-associativity and cuckoo hashing. In some implementations, hits involve a single lookup (e.g., using one or more hashing functions), incurring latency and energy costs of a cache with a low number of ways, and misses involve using additional tag lookups off a main (e.g., critical) path for the memory to yield a large number of replacement candidates for an incoming block. Associativity is provided by increasing the number of replacement candidates, but not the number of cache ways.

Other aspects are directed to cache-based memory, such as described in Appendices C and D referenced above, and which may be implemented with cache partitioning. For example, caches may be implemented with several partitions having sizes specified at cache line granularity, and can be effected while maintaining high associativity and isolation among partitions, and can facilitate soft-pinning on a large portion of cache lines. Capacity allocations can be enforced by controlling the replacement process, by partitioning a portion (e.g., 90%) of the cache and leaving an un-partitioned region. The un-partitioned region is used to facilitate slack in partition sizing while maintaining isolation (e.g., a partition may be grown against the un-partitioned region instead of interfering with one another), and/or to facilitate an increase of associativity of the underlying cache design. Associativity, sizing and interference can be controlled independently from a number of cache partitions and partition behavior (e.g., relating to access patterns and/or hit and miss frequencies).

In various embodiments, data is moved to locations permitting a single lookup by identifying a subset of locations corresponding to a single-type access to memory. For instance, a function such as described herein may be executed by a memory controller, to generate an output identifying candidate locations. These candidate locations, which are identified via the execution of such a function, thus correspond to locations identified via a single lookup (single execution of a function) that generates an output identifying the subset of the candidate locations. Data can be moved to one of the subset locations based on the generated output, and therein preserving the ability to access the data via a single lookup.

The various embodiments herein are implemented in different environments, apparatuses and systems. For instance, various applications may include multi-processor or SMT (simultaneous multithreading) processor applications, translation look-aside buffers, and coherence directories. In addition, various approaches and apparatuses are implemented to mitigate side-channel attacks that exploit shared caches by eliminating cache interference, enhancing security-sensitive code (e.g., private and public-key encryption).

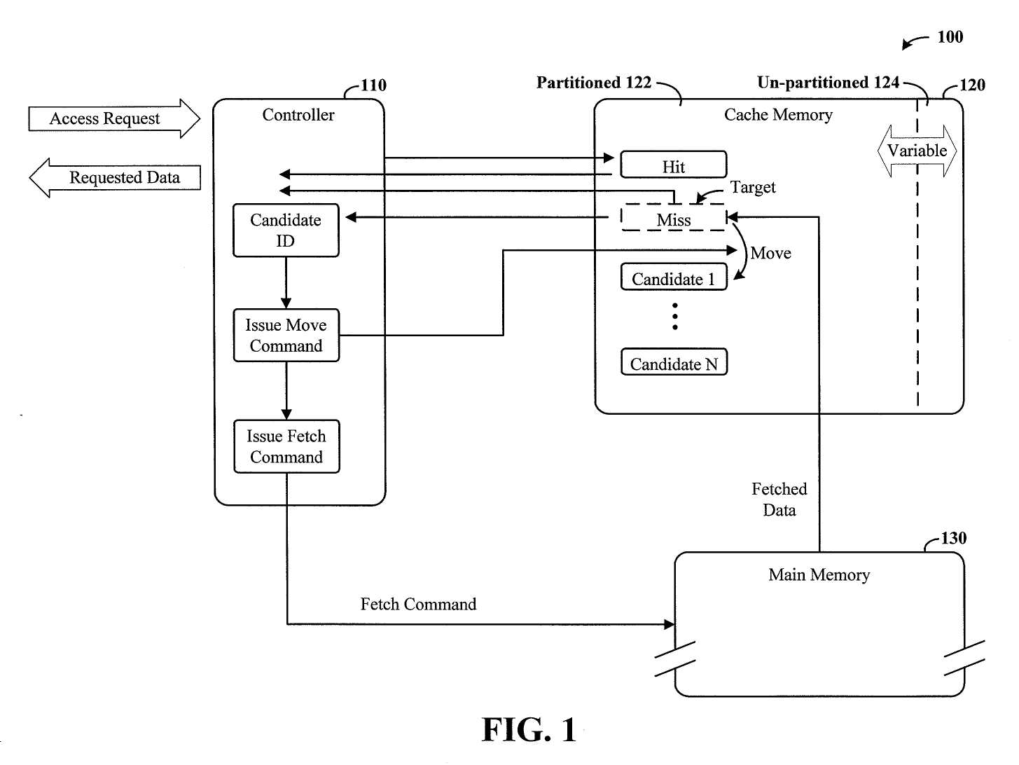

Turning now to the figures, FIG. 1 shows an apparatus 100 including a memory controller 110 and related memory circuits 120 and 130, in accordance with one or more example embodiments. The controller 110 operates responsive to data access requests by returning data from cache memory 120 using a single lookup to a cache line when a cache hit occurs, and operates as follows in response to a cache miss. Candidate ID locations are identified (one or several as shown) for moving data from a target location to make room for the requested data. The controller 110 selects a candidate location and issues a move command that moves the data from the target location to the candidate location, while a fetch command is issued to fetch the requested data from main memory 130. The fetched data is then written in the (now vacated) target location in the cache memory 120. Access is thus facilitated with a single lookup to the target location (e.g., via locations identified by a single execution of a lookup function), with replacement being effected concurrently with a fetch command.

In a more particular embodiment, the cache memory 120 includes partitioned memory space 122 and un-partitioned memory space 124. The size of the respective spaces is variable as represented by way of example with a vertical dashed line (e.g., with partitioned space making up 80% or 90% of the cache memory 120). As additional space is needed the controller 110 increases the size of the partitioned space 122, without necessarily increasing the size of one or more of respective partitions in the partitioned space, such as by allocating additional space within already-defined partitions. As less space is needed, the controller 110 decreases the size of the partitioned space 122, and accordingly decreases the size of one or more the respective partitions.

In some embodiments involving the partitioning shown in FIG. 1 and described above, the partitioned space is managed as follows. Demotion rates are defined for demoting data from each of a plurality of isolated partitions in the portioned space 122, based upon an insertion rate for inserting data into the partitioned space. The size of one or more of the isolated partitions is increased in response to the demotion rate for the partition exceeding a predefined threshold demotion rate. Correspondingly, the size of one of the isolated partitions is decreased in response to the demotion rate for the partition falling below a predefined threshold. The memory controller 110 may be implemented to control the size of the partitioned space in this manner.

The controller 110 operates to control the size of partitions in a variety of manners. In some embodiments, the partitions are increased in size in response to determining that fetched data will increase the amount of data in the cache beyond a level that a current size of the partitioned memory circuit region. In other embodiments, the controller 110 increases and decreases the size of the isolated partitions independently from a number of the cache partitions and accesses to the partitions, or in response to feedback indicative of a condition of the memory circuit (e.g., adjusting size based on how much the partitions outgrow their target allocations).

In accordance with various embodiments, the controller 110 evicts data from the one of the plurality of candidate locations, prior to moving an existing set of data from a target location to the one of the plurality of candidate locations. In some implementations, the controller 110 assigns a usage history data, such as a time stamp or other historical information (e.g., a number of accesses) to the fetched data, stores the time stamp as part of the fetched data in the target location, and evicts data from one of the plurality of candidate locations based upon the time stamp.

In other embodiments, the controller 110 defines directory sharer tag data for processors sharing access to memory blocks using a variable number of directory tags. For cache lines accessed by less than a threshold number of processors, a single directory tag is defined, and which associates each cache line with the processor or processors that access the cache line. For each cache line accessed by a number of processors that is equal to or greater than the threshold number of processors, at least two directory tags are identified for each cache line, with each of the at least two directory tags associating the cache line with at least one of the processors that access the cache line.

In various embodiments referring to the definition/storage of sharer tag data, such data is stored for a cache or tracked cache, which are in turn accessed by one or more processors. For instance, lines of data used by a cache can be tracked and assigned a sharer tag, and are accordingly accessed/used by the processors that share the cache.

In some implementations, defining at least two directory tags includes defining an additional directory tag, in response to at least one existing directory tags being assigned to a threshold number of processors. With this approach, the size of the tags can be limited as additional processors that access the memory circuit are added.

In accordance with further sharer-based embodiments, a number of sharer processors that access memory are tracked. Sharer sets (sets of such core processors that access a common memory location) are tracked using a variable number of tags per address. The number of bits per tracked sharer are monitored and used to scale the size of respective sharer sets (e.g., remaining constant or increasing logarithmically) with the number of cores. Lines with one or a few sharers use a single directory tag with a limited pointer format, and widely shared lines employ a multi-tag format using a hybrid pointer/bit-vector organization that scales logarithmically and can track tens of thousands of cores. Such an approach can be implemented, for example, with a relatively small amount of overprovisioning (e.g., 5-10%).

Operations upon sharer sets are supported as follows. A sharer is added to a share corresponding to a particular line in response to that sharer requesting the line. A sharer is removed when it writes back the line. For an invalidation or downgrade, all sharers are retrieved. On a directory miss, a replacement process allocates one tag for an incoming line with index 0 (possibly evicting another tag). This tag uses a limited pointer format, and further sharers use additional pointers.

When a sharer needs to be added and all the pointers are used, the line is switched to a multi-tag format as follows: First, bit-vector leaves are allocated for existing pointers and the new sharer. Leaf tags are then populated with the existing and new sharers. The limited pointer tag then transitions to the root bit-vector format, setting appropriate bits to 1. When a sharer needs to be removed (e.g., due to clean or dirty writebacks), an inverse procedure is used. When a line loses all its sharers, all of its directory tags are marked as invalid.

Invalidations are carried out for both coherence (on a request for exclusive access, the directory needs to invalidate all other copies of the line) and evictions in the directory. Downgrades are carried out based on coherence (e.g., a request for read on an exclusive line needs to downgrade the exclusive sharer, if any). For coherence-induced invalidations, all sharers are sent invalidation messages. If the address is represented in the hierarchical bit-vector format, all leaf bit-vectors are marked as invalid, and the root bit-vector tag transitions to the limited pointer format, which then encodes the index of the requesting core. Eviction-induced invalidations are implemented with a specific tag. Limited pointer and root bit-vector tag evictions are treated like coherence-based invalidations, invalidating all sharers so that the tag can be reused. Leaf bit-vector evictions invalidate a subset of sharers represented in the tag.

In some sharer-based implementations, hierarchical bit-vector representations with more than two levels are used. One such two-level approach scales to 256 sharers with about 16 bits devoted to track sharers (pointers/bit-vectors) per tag, to 1024 sharers with about 32 bits, and to 4096 sharers with about 64 bits. A three-level representation covers 4096 sharers with about 16 bits, 32768 sharers with about 32 bits, and 256K sharers with about 64 bits. Four-level implementations can reach into the millions of cores.

Sharer-based scheduling policies are implemented as follows, in accordance with one or more example embodiments. Concurrent operations to the same address are serialized and processed in FCFS order. The array is pipelined, and concurrent non-conflicting lookups and writes are allowed, with one replacement at a time. If the replacement process needs to move or evict a tag from an address of a concurrent request, it waits until that request has finished, and preserves atomicity. An insertion queue is used to mitigate latency introduced by the replacement process. Tags are allocated in the insertion queue first, and then inserted in the array (e.g., a 4-entry insertion queue may be used to hide replacement delay for sufficiently provisioned directories, where replacements are short, while severely underprovisioned directories employ an 8-entry queue). To mitigate deadlock, operations that require allocating new tags and block on a full insertion queue are not started until they allocate their space. This facilitates the movement or eviction of tags belonging to an address of a blocking request.

Various embodiments are directed to achieving high associativity with a small number of physical ways, addressing a trade-off between associativity and access latency and/or energy. In an embodiment, associativity is improved while keeping the number of possible locations (i.e., ways) of each block small, with the associativity being set by the number of replacement candidates on an eviction. Blocks are stored in only one location per way, so hits involve a single lookup. On a replacement, a block that conflicts with the incoming block is moved to a non-conflicting location rather than being evicted. On a miss, a tag array is perused to obtain additional replacement candidates, a candidate (e.g., best candidate) is selected and evicted, and one or more relocations is performed to accommodate an incoming block. This replacement may be effected off the main/critical path, concurrently with the miss and other lookups, so the replacement has no effect on access latency. In connection with various such embodiments, it has been discovered that such an approach decouples associativity from the number of ways or locations that a block can be in, and with the associativity being set by a number of replacement candidates.

In various embodiments, a memory cache apparatus as discussed herein is implemented as follows. Each way is indexed by a different hash function, and a cache block is allowed to reside only in a single position on each way, with the position given by the hash value of the block's address. Cache hits are implemented similarly as in a skew-associative cache, using a single lookup to a small number of ways. For general information regarding skew-associative caches, and for specific information regarding approaches for managing cache hits, reference may be made to A. Seznec, “A case for two-way skewed-associative caches,” in Proc. of the 20th Annual Intl. Symp. on Computer Architecture (1993), which is fully incorporated herein by reference.

On a cache miss, the apparatus exploits the fact that two blocks that conflict on a way often do not conflict on the other ways, to increase the number of replacement candidates, and performs a replacement over multiple steps as follows. A tag array is perused to identify a set of replacement candidates, and a candidate preferred by a replacement policy (e.g., a least recently used block for LRU, as may be based on time-stamps) is selected and evicted. Block relocations are carried out to accommodate an incoming block at a proper/target location. The replacement process is carried out while fetching the incoming block from the memory hierarchy, and thus does not affect the time to serve the cache miss.

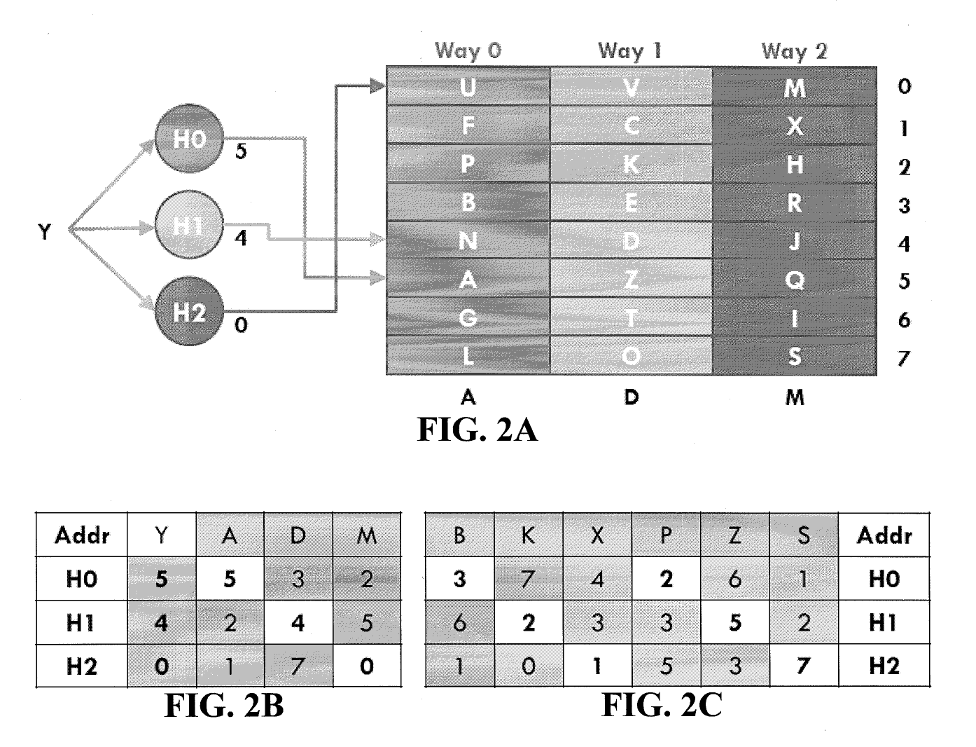

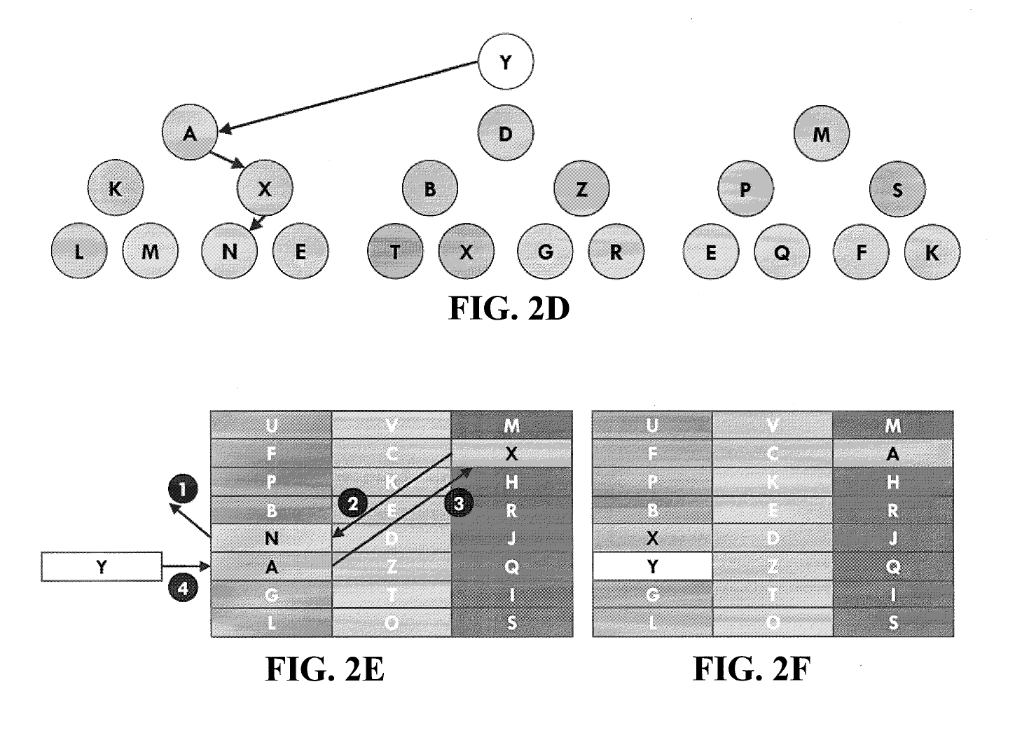

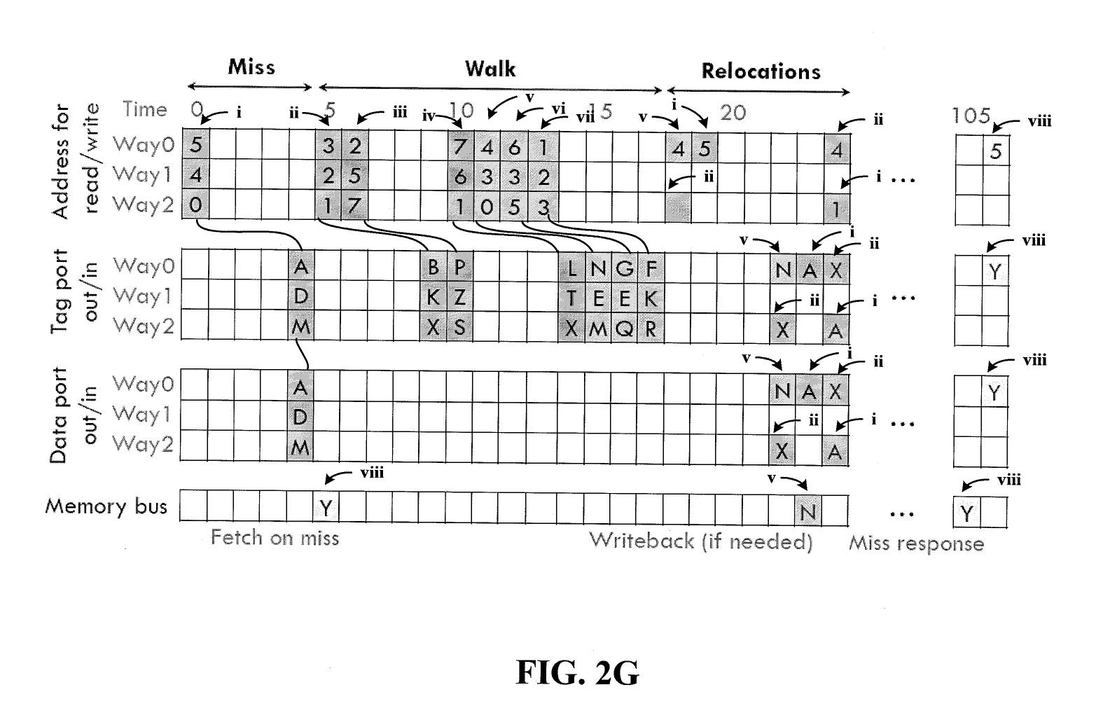

Referring to FIGS. 2A-2G, the operation of the replacement process in memory access/control is carried out as follows, using a small 3-way cache with 8 lines per way as an example implementation. Looking ahead, FIG. 2G shows the timeline of reads and writes to tag and data arrays, as well as a memory bus, with addresses and hash values obtained in the same access being labeled via common numerals (i-viii) and connecting lines where applicable. Beginning with FIG. 2A, letters A-Z denote cache blocks, and numbers denote hash values, as initial contents of the cache and a miss for address Y that triggers a cache miss process. Initially, the addresses returned by the tag lookup for Y are the only replacement candidates for the incoming block (addresses A, D and M), and these are the first-level candidates.

A controller (e.g., 110 of FIG. 1) starts a walk to expand the number of candidates by computing the hash values of these addresses, as shown in FIG. 2B. One of the hash values always matches the hash value of the incoming block, and the others denote the positions in the array where each of the current replacement candidates could be moved in order to accommodate an incoming block. For example, referring to column A in FIG. 2B, block A can be moved to line 2 in way 1 (evicting K), or to line 1 in way 2 (evicting X), and incoming block Y can be written in line 5 of way 0.

The six non-matching hash values in FIG. 2B are used to perform two accesses, giving an additional set of six second-level replacement candidates, as shown in FIG. 2C (addresses B, K, X, P, Z, and S). This process can be repeated one or more times to obtain additional replacement candidates. In this example, a third level is achieved to obtain 21 (3+6+12) replacement candidates, which is shown in the tree structure of FIG. 2D. A replacement policy is implemented (e.g., an algorithm executed by controller 110) to select a replacement candidate, such as by selecting a least-recently used candidate. For exemplary discussion, block N is selected as the best candidate, as shown via arrows in FIG. 2D.

As shown in FIG. 2E, block N is evicted and its ancestors in the tree (both data and tags) are relocated to accommodate the incoming block Y. This involves reading and writing the tags and data to their new locations, as the timeline in FIG. 2G indicates. FIG. 2F shows the contents of the cache after the replacement process is finished, with N evicted and Y in the cache. Each of N and Y use way 0, but completely different locations.

The following discussion characterizes more specific approaches to carrying out memory access. Such approaches may, for example, be implemented with an apparatus such as that shown in FIG. 1 (e.g., with controller 110 operating with a cache as shown or otherwise). A cache with W ways in which the walk is limited to L levels has the following characteristics. Replacement candidates (R), assuming no repeats when expanding the tree, are defined as follows:

R=WΣₗ₌₀^{L-1}(W−1)^{l}

Replacement process energy (Emiss) is defined as follows, with the energies to read/write a tag or data in a single way being denoted Ert, Ewt, Erd and Ewd, with

Emiss=Ewalk+Erelocs=R×Ert+m×(Ert+Erd+Ewt+Ewd),

where mε{0, . . . , L−1} is the number of relocations. Reads and writes to the data array grow with L (i.e., logarithmically with R). Replacement process latency grows with the number of levels, unless there are so many accesses on each level that they fully cover the latency of a tag array read:

T_{walk}=Σₗ₌₀^{L-1}max(T_{tag},(W−1)^{l})

This means that, for W>2, a large number of candidates can be obtained in a small amount of delay. For example, FIG. 2G assumes a tag read delay of 4 cycles, and shows the walk process for 21 candidates (3 levels), which completes in 4×3=12 cycles. The process finishes in 20 cycles, which is much earlier than, e.g., 100 cycles used to retrieve an incoming block from main memory.

In some embodiments, to implement the replacement process, a cache controller executes one hash function per way. Such hash functions range from extremely simple (e.g., bit selection) to exceedingly complex (e.g., cryptographic hash functions like SHA-1). In some implementations, H3 hash functions such as those described in J. L. Carter and M. N. Wegman, “Universal classes of hash functions (extended abstract),” in Proc. of the 9th Annual ACM Symposium on Theory of Computing (1977) which is fully incorporated herein by reference, are used with such hash functions. The controller stores the positions of the replacement candidates visited during the walk, as well as the position of the best eviction candidate (e.g., by storing hash values). For instance, 63 bits of state to track candidates (21 hash values×3 bits/value) can be stored to effect such an approach. For larger caches such as a 3 MB cache with 1 MB per way and 64-byte lines (requiring 14 bits/hash value), 294 bits are stored. The controller also buffers tags and data of the L lines it reads and writes on a relocation. Since the number of levels can be small (e.g., 2 or 3), this can entail a small overhead.

To avoid increasing cache latency, and in accordance with various example embodiments, the replacement process is run concurrently with all other operations (e.g., tag/data reads and writes due to hits, write-backs, invalidations). The walk process can run concurrently without interference. For instance, if the walk identifies the best eviction candidate to be a block that was accessed (e.g., with a hit) in the interim, the block may be evicted anyway. In some embodiments involving smaller caches (e.g., highly-associative but small TLBs or first-level caches), the best two or three eviction candidates are tracked and discarded if they are accessed while the walk process is running.

In the second part of the replacement process in which relocations take place, the controller blocks intervening operations to at most L positions while blocks in these positions are being relocated. In some implementations, concurrent replacements are carried out to increase bandwidth utilization when the cache is close to bandwidth saturation.

Various additions and modifications can be made to the apparatuses and approaches as described herein, for various implementations. In one embodiment, repeats are avoided as follows. Addresses visited during the walk are inserted in a Bloom filter, and the walk is not continued through addresses that are already represented in the filter. For general information regarding Bloom filters, and for specific information regarding the implementation of such a filter in accordance with one or more embodiments, reference may be made to B. H. Bloom, “Space/time trade-offs in hash coding with allowable errors,” Commun. ACM, Vol. 13, No. 7 (1970), which is fully incorporated herein by reference.

Walks are carried out using one or more approaches such as described in the above-referenced provisional patent document. For instance, a breadth-first search (BFS) for candidates, fully expanding all levels, a depth-first search (DFS), moving towards higher levels of replacement candidates, or a hybrid BFS+DFS approach can be carried out to increase associativity.

Similarly, a variety of replacement policies can be implemented to evict candidates to make room for a new block, such as those described in the above-referenced provisional patent document. For example, a full least-recently used (LRU) approach or bucketed LRU approach can be used. Certain embodiments use full LRU, in which a global timestamp counter is used with a timestamp field being added to each block in the cache. On each access, the timestamp counter is incremented, and the timestamp field is updated to the current counter value. On a replacement, the controller selects the replacement candidate with the lowest timestamp (in mod 2n arithmetic). This design requires very simple logic, and timestamps are generally large (e.g., 32 bits) to mitigate wrap-arounds. Various embodiments use a bucketed LRU approach, in which timestamps are made small and the controller increases the timestamp counter once every k accesses. For example, with k=5% of the cache size and n=8 bits per timestamp, it is rare for a block to survive a wrap-around without being either accessed or evicted.

Associativity may be distributed in a variety of manners, to suit different applications. In some embodiments, a cache is divided into a cache array that holds tags and data, implements associative lookups by block address, and, on a replacement, gives a list of replacement candidates that can be evicted. A replacement policy maintains a global rank of which cache blocks to replace. An LRU approach is used in which the order of elements in each set is stored, such as by using timestamps. Blocks with a higher preference to be evicted are given a higher rank r. In a cache with B blocks, rε[0, . . . , B−1]. To make the rest of the analysis independent of cache size, a block's eviction priority is defined as its rank normalized to [0, 1] (i.e., e=r/(B−1)). The associativity distribution is defined as the probability distribution of the eviction priorities of evicted blocks. The associativity distribution characterizes the quality of the replacement decisions made by the cache in a way that is independent of the replacement policy, which decouples how the array performs from ill-effects from the replacement policy.

The cache approaches as discussed herein can be implemented in a variety of manners, using various apparatuses and cache approaches. In some embodiments, highly associative first-level caches and TLBs are implemented for multithreaded cores. In some implementations, adaptive replacement schemes that use high associativity are implemented based on a metric indicative of when the use would improve performance, saving cache bandwidth and energy when high associativity is not needed, or even making associativity a software-controlled property.

As discussed herein, various embodiments are directed to cache-based approaches involving a partitioning of a cache, and management of partitioned (managed) regions using un-partitioned (unmanaged) regions to allow the partitioned region to grow or shrink accordingly. Such embodiments may be implemented independently, or with, the cache access approaches such as those discussed herein and shown in the figures, or other approaches such as skew-associative caches. In various embodiments, caches are implemented with tens of partitions with sizes specified at cache line granularity, while maintaining high associativity and strong isolation among partitions. Partitions can be dynamically resized, created and removed. Capacity allocations are enforced by controlling the replacement process, using a replacement policy (e.g., LRU) to rank lines within each partition. Partitions can slightly outgrow their target allocations, borrowing space from a small un-partitioned region of the cache, and not from other partitions. Hence, destructive interference between partitions is eliminated. Sizes are maintained by matching the average rates at which lines enter and leave each partition. By controlling partition sizes this way, the amount of cache space that has to be left un-partitioned for can be both small (e.g., around 5-15% in a 4-way cache as described herein) and independent of the number of partitions or their sizes. Negative feedback is used to control partition sizes. Bits are added to each tag (e.g., 6 bits to support 32 partitions), and a cache controller tracks about 256 bits of state per partition (e.g., using a few narrow adders and comparators for control logic). Further, line placement is not restricted, with lines from all partitions sharing the cache.

Partition sizes are enforced when replaced, in which one line is evicted from a set of replacement candidates. In a partitioned cache, this set may include good candidates from other partitions (e.g., lines that the owning partition would have to evict anyway). The rates of insertions and evictions from each partition are matched on an average-type basis, allowing flexible operation. Candidate selection for replacement is dynamically adjusted, based on the insertion rate of each partition.

The division between regions is carried out by tagging each line as either partitioned or un-partitioned, and region sizes are set by controlling the flow of lines between the two regions. A base replacement policy (e.g., LRU) ranks lines as in an undivided cache, and can be carried out independent of the existence of the two regions. On an eviction, lines in the un-partitioned region are prioritized for eviction over portioned lines. The un-partitioned region is sized so that it captures most evictions, making evictions in the partitioned region negligible. Such an approach may, for example, be carried out using the apparatus of FIG. 1, with regions 122 and 124. In some implementations, the un-partitioned region (124) is set to about 30% of the size of the cache memory in order to make evictions in the partitioned region negligible. Incoming lines are inserted in the partitioned region, eventually demoted to the un-partitioned region, and either evicted from there, or promoted if they receive a hit. Promotions and demotions can be implemented without necessarily physically moving the line, but instead changing the line's tag.

In some implementations, one line is demoted to the un-partitioned region on each replacement or promotion. The fraction of the cache devoted to the partitioned (managed) and un-partitioned (unmanaged) regions are denoted by m and u, respectively. Ignoring the flow of promotions (which can be small compared to the evictions), by demoting one line on each replacement, the associativity distribution for demotions inside the partitioned region is:

$${F}_{M} ( x ) ≅ {\sum }_{i = 1}^{R - 1} B ( i , R ) {R}_{{A}_{i}} ( x ) , \\ where$$

$$B ( i , R ) = ( \begin{matrix}R \\ i\end{matrix} ) {( 1 - u )}^{i} {u}^{R \text{-} i} ,$$

is the probability that i of the R replacement candidates are in the partitioned region (a binomial distribution), and

F_{A}_{ᵢ}(X)=xⁱ

is the nominal associativity distribution with i replacement candidates.

To maintain the sizes of the two regions under control, various embodiments do not demote exactly one candidate per eviction, but rather demotes one on average. For example, some evictions might not yield any candidates with high eviction priority from the partitioned region, while others might find two or more. The controller (e.g., 110) selects a threshold value, referred to herein as the aperture (A), over which it will demote every candidate that it finds. For example, if A=0.05, the controller demotes every candidate that is on the top 5% of eviction priorities (i.e., e>0.95). Since, on average, R·m of the candidates are from the partitioned region, maintaining the sizes requires an aperture A=1/R·m. The associativity distribution in the partitioned region is uniform ˜U[1−A, 1], so the CDF is:

$${F}_{M} ( x ) = \{ \begin{matrix}0 & if & x < 1 - A \\ \frac{x - ( 1 - A )}{A} & if & 1 - A \leq x \leq 1 \\ 1 & if & x > 1\end{matrix}$$

Partitioning can be effected in a variety of manners. In some embodiments, P partitions of target sizes T1, . . . , TP are used, so that

Σᵢ₌₁^{P}Tᵢ=m

(i.e., partition sizes are expressed as a fraction of the total cache size). These target sizes are used with an allocation policy (e.g., utility-based cache partitioning (UCP) or software mechanisms), with partitions having actual sizes S1, . . . , SP and insertion rates, referred to as churns, C1, . . . , CP (a partition's churn is measured in insertions per unit of time).

The actual size of each partition is thus held close to its target size by matching its demotion rate with its churn. This is achieved by controlling how demotions are done. Instead of having one aperture for the partitioned region, there is one aperture per partition, Ai. On each replacement, all the candidates below their partitions' apertures are demoted. A partition's incoming line can demote others' lines. In some embodiments in which partitions have similar behavior, the apertures are set to be equal (Ai=1/R·m) to maintain their sizes. This is effected independently of how the base replacement policy ranks candidates, as demotions are made from the bottom Ai portion from each partition. Furthermore, the aperture is independent from the number of partitions.

In other embodiments involving partitions with different behaviors, apertures are implemented to accommodate for the differences. For instance, a larger aperture is used for partitions with a higher churn than the average for the partitions, and this partition's lines are demoted at a higher frequency. A larger aperture is also used for partitions having smaller than the average, as instances of finding replacement candidates from that partition are relatively rare. In many implementations, partitions with a larger churn and/or a smaller size than the average will have a larger aperture, and partitions with a smaller churn and/or a larger size than the average will have a smaller aperture.

In one particular instance, 4 equally sized partitions (S1=S2=S3=S4) are implemented in which the first partition has twice the churn as the others (C1=2C2, C2=C3=C4). The cache examines R=16 replacement candidates per eviction, and the partitioned region takes m=62.5% of the cache. On each replacement, R·m=16·0.625=10 candidates are in the partitioned region on average. To maintain the partitions' sizes, on average, for every 5 demotions, 2 should be done from partition 1, and 1 demotion from each of partitions 2, 3 and 4. For every 5 demotions, 5·10=50 candidates are obtained from the partitioned region on average, 50/4=12.5 candidates per partition since they are equally sized. The apertures are thus set to A1=2/12.5=16% for partition 1, and A2=A3=A4=1/12.5=8% for the other partitions. Hence, partitions with disparate churns or sizes result in unevenly distributed associativity. In various implementations involving partitions with different sizes Si and churns Ci, the aperture of each partition is derived. Out of the R·m replacement candidates per demotion that fall in the partitioned region, a fraction

$$\frac{{S}_{i}^{-}}{{\sum }_{k = 1}^{P} {S}_{k}}$$

are from partition i, and lines are demoted at a fractional rate of

$$\frac{{C}_{i}}{{\sum }_{k = 1}^{P} {C}_{k}}$$

in this partition. Therefore,

$${A}_{i} = \frac{{C}_{i}}{{\sum }_{k = 1}^{P} {C}_{k}} \frac{{\sum }_{k = 1}^{P} {S}_{k}}{{S}_{i}} \frac{1}{R \cdot m} . \qquad$$

In some implementation, stability is further achieved by setting a maximum aperture Amax. If using the equation for Aᵢ above yields an aperture larger than Amax, options include letting the partition grow beyond its target allocation, borrowing space from the un-partitioned region; allowing low-churn/size-high-churn/size partition interference by inserting its lines in the un-partitioned region and throttling its churn; or allowing high-churn/size-low-churn/size partition interference by reducing the size of one or more low-churn partitions and allocating that space to the high-churn partition until its aperture is lower than Amax.

In some implementations, partitions are allowed to grow as above with extra slack sizing, determined in accordance with the following. When several partitions 1, . . . , Q (Q<P) have very small sizes (e.g., 1 line each) and high churns, each partition will grow until it is large enough that its Ci/Si ratio can be handled with aperture Amax. This minimum stable size (MSS) is:

$${MSS}_{j} = \frac{{C}_{j}}{{\sum }_{k = 1}^{P} {C}_{k}} \frac{{\sum }_{k = 1}^{P} {S}_{k}}{{A}_{ma x} \cdot R \cdot m} , ∀ j ∈ \{ 1 , … , Q \} .$$

Additionally, in the worst case, all other partitions (Q+1, . . . P) have zero churn, so

Σₖ₌₁^{P}Cₖ=Σₖ₌₁^{Q}Cₖ

and assuming

$${\sum }_{k = 1}^{P} {S}_{k} ≅ m , {\sum }_{j = 1}^{Q} {MSS}_{j} ≅ \frac{1}{( {A}_{ma x} R )} .$$

For the exact derivation,

Σₖ₌₁^{P}Sₖ=Σₖ₌₁^{P}Tₖ+Σⱼ₌₁^{Q}MSSⱼ,

and the target sizes achieve

Σₖ₌₁^{P}Tₖ=m.

By substituting on the previous equation,

Σⱼ₌1^{Q}MSSⱼ=1/(AₘₐₓR−1/m)

For reasonable values of Amax, R and m, AmaxR>>1/m, and therefore

$${\sum }_{j = 1}^{Q} {MSS}_{j} ≅ \frac{1}{( {A}_{ma x} R )}$$

is an approximation. Hence, sizing the un-partitioned region with an extra 1/(AmaxR) of the cache maintains the desired number of evictions from the partitioned region, regardless of the number of partitions. For example, if the cache has R=52 candidates, with Amax=0.4, an extra 1/0.4·52=4.8% space is assigned to the un-partitioned region. Given that this is an acceptable size, partitions can be allowed to outgrow their allocations, disallowing inter-partition interference.

In various implementations, the upsizing and downsizing of partitions resized at high frequency are controlled progressively and in multiple steps. In some implementations, a variable number of partitions are used, and partitions are created and deleted dynamically. Deleting an existing partition may, for example, involve setting the target size of the partition to 0 (zero), and its aperture to 1.0. When most or all of the lines in the partition have been demoted, the partition identifier can be reused for a new partition.

A variety of cache controllers can be implemented to control partition sizes and space allocation with an un-partitioned region as discussed herein. In some embodiments, a controller is given target sizes of each partition and the partition ID of each cache access. Partition sizes are set by an external resource allocation policy (such as UCP), and partition IDs depending upon the specific application. One or more partitions are used per thread, each line is tagged with its partition ID, and, on each replacement, evictions are performed from the un-partitioned region and demotions are performed from the partitioned region. Feedback-based aperture control is used to determine aperture size (e.g., instead of using calculations as above), and setpoint-based demotions are used to demote lines according to a desired aperture without necessarily knowing eviction priorities.

In various implementations, feedback-based aperture control is carried out as follows. The aperture of each partition is derived using negative feedback alone, letting partitions slightly outgrow their target allocations, borrowing from the un-partitioned region, and adjusting apertures based on how much the partitions outgrow their target allocations. In a specific implementation, each aperture Ai is derived as a function of Si, as follows:

$${A}_{i} ( {S}_{i} ) = \{ \begin{matrix}0 & if & {S}_{i} \leq {T}_{i} \\ \frac{{A}_{ma x}}{slack} \frac{{S}_{i} - {T}_{i}}{{T}_{i}} & if & {T}_{i} < {S}_{i} \leq ( 1 + slack ) {T}_{i} \\ {A}_{ma x} & if & {S}_{i} > ( 1 + slack ) {T}_{i} ,\end{matrix}$$

where Ti is the partition's target size, and slack is the fraction of the target size at which the aperture reaches Amax and tapers off. An increase in size causes an increase in aperture, attenuating the size increase. In the linear region, ΔSi=Si−Ti=slack·Si (Ai/Amax). Accordingly:

$$Δ {S}_{i} = \frac{slack}{{A}_{ma x}} {S}_{i} \frac{{C}_{i} {\sum }_{k = 1}^{P} {S}_{k}}{{S}_{i} {\sum }_{k = 1}^{P} {C}_{k}} \frac{1}{R \cdot m} = \frac{slack}{{A}_{ma x}} \frac{{C}_{i}}{{\sum }_{k = 1}^{P} {C}_{k}} \frac{1}{R} .$$

Therefore, the aggregate outgrow for all partitions in steady-state is:

$${\sum }_{i = 1}^{P} Δ {S}_{i} = \frac{slack}{{A}_{ma x} \cdot R} ,$$

which is accounted for in resizing the un-partitioned region.

In various embodiments, setpoint-based demotions are carried out as follows, to demote blocks without necessarily tracking eviction priorities. A coarse-timestamp such as LRU is used as a base replacement policy. A timestamp counter is set for each partition and incremented every ki accesses, and accessed lines are tagged with the current timestamp value. Using 8-bit timestamps with ki= 1/16 of the partition's size, wraparounds are mitigated. To perform demotions, a setpoint timestamp is set and all candidates that are below the setpoint (in modulo 256 arithmetic) are demoted if the partition is exceeding its target size. This setpoint is adjusted every c candidates seen from each partition in the following fashion: counters for candidates seen from this partition and for the number of demoted candidates, di, are used. Every time the candidates counter reaches c, if di>c·Ai (i.e., di/c>Ai), the partition's setpoint is incremented. If di<c·Ai, the setpoint is decremented. Both counters are then reset. The setpoint is increased every time the timestamp is increased (i.e., every ki accesses), so that the distance between both remains constant. With these approaches, the aperture can be tracked indirectly, without necessarily profiling the distribution of timestamps in the partition (e.g., using c=256 candidates). Where c is constant and target allocations are varied sparingly, a small 8-entry demotion thresholds lookup table (e.g., as in the above-referenced provisional application) is used, which gives the di threshold for different size ranges. For example, if when we c=256 candidates is reached for a partition and the partition's size is anywhere between 1034 and 1066 lines, having more/less than 64 demotions in this interval will cause the setpoint to be incremented/decremented. Such a table can be filled at resize time, and used for every c candidates seen. Such approaches can be used with timestamp LRU as discussed above, as well as other approaches such as LFU (least frequently used) in which a setpoint access frequency can be set.

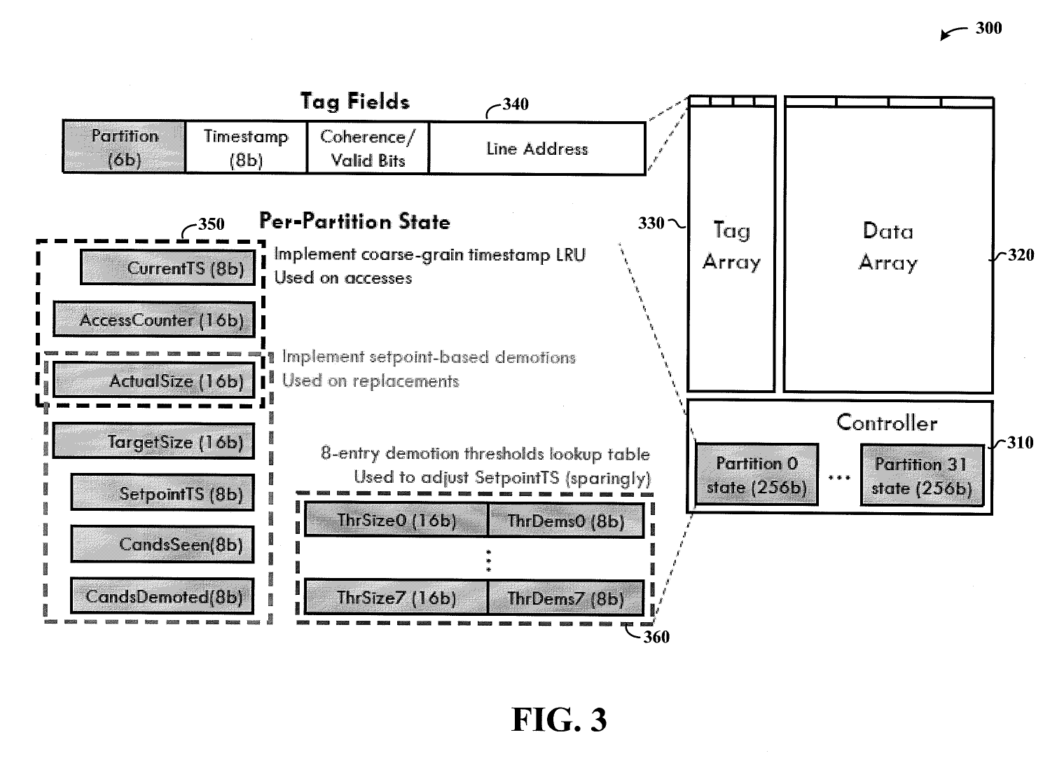

Turning now to FIG. 3, an apparatus and approach 300 involves partition control and related tag fields, in accordance with another example embodiment. A controller 310 controls the size of partitioned and un-partitioned regions, such as shown in FIG. 1, using a data array 320 and tag array 330 having tags as exemplified in tag 340. The controller 310 tags each line with its partition ID, and an extra ID is used for the un-partitioned region. For example, with P=32 partitions, 33 identifiers, or 6 bits per tag, are used. If tags are nominally 64 bits, and cache lines are 64 bytes, this is a 1.01% increase in cache state. Each tag 340 also has an 8-bit timestamp field to implement the LRU replacement policy.

In a pre-partition state as shown at 350, for each partition, the controller 310 keeps track of 8-bit and 16-bit registers, the latter of which tracks seizes or quantities relative to size with a cache having 216 lines. Each of these registers is kept in partition-indexed register files. With 32K lines per bank, this amounts to 256 bits per partition, and for 32 partitions and 4 banks (for an 8 MB cache), this represents 4 KBytes, which is less than a 0.5% state overhead.

For each hit, the controller 310 writes the partition's CurrentTS into the tag's timestamp field and increases the partition's Access-Counter. This counter is used to drive the timestamp registers forward: when AccessCounter reaches ActualSize/16, the counter is reset and both timestamp registers, CurrentTS and SetpointTS, are increased. This scheme can be implemented similarly to the coarse-grained timestamp LRU replacement policy, with the timestamp and access counter being per partition. Additionally, if the tag's Partition field indicates that the line was in the un-partitioned region, this is a promotion, so ActualSize is increased and Partition is written when updating the Timestamp field.

On each miss, the controller 310 examines the replacement candidates and performs one demotion on average, chooses the candidate to evict, and inserts the incoming line. All candidates are checked for demotion: a candidate from partition p is demoted when both ActualSize[p]>TargetSize[p] (i.e., the partition is over its target size) and the candidate's Timestamp field is not in between SetpointTS[p] and CurrentTS[p], which uses two comparisons to decide. If the candidate is demoted, the tag's Partition field is changed to the un-partitioned region, its Timestamp field is updated to the un-partitioned region's timestamp, ActualSize[p] is decreased, and CandsDemoted[p] is increased. Regardless of whether the candidate is demoted or not, CandsSeen[p] is increased. The controller 310 also evicts the candidate from the un-partitioned region with the oldest timestamp. If all candidates come from the partitioned region, the controller chooses one of the demoted candidates arbitrarily, and if no lines are selected for demotion, it chooses among all the candidates.

An incoming line is inserted into the cache as usual, with its Timestamp field set to its partition's CurrentTS register, and its ActualSize is increased. As in a hit, AccessCounter is increased and the timestamps are increased if it reaches ActualSize/16. Additionally, to implement the setpoint adjustment scheme as discussed above, partition p's setpoint is adjusted when CandsSeen[p] crosses 0. At this point, the controller 310 has seen 256 candidates from p since the last time it crossed 0 (since the counter is 8 bits), and has demoted CandsDemoted[p] of them. The controller 310 finds the first entry K in the 8-entry demotion thresholds lookup table (e.g., as discussed above) so that the partition's threshold size, ThrSize[K][p], is lower than its current size, ActualSize[p]. The controller 310 then compares CandsDemoted[p] with the demotion threshold, ThrDems[K][p] at 360. If the demoted candidates exceed the threshold, SetpointTS[p] is decreased, while if they are below the threshold, the setpoint is increased. CandsDemoted[p] is the reset.

The controller 310 uses counter updates and comparisons on either 8 or 16-bit registers, such as by implementing a few narrow adders and comparators. On misses, the controller decides whether to demote every candidate it sees, with each demotion check using a few comparisons and counter updates. In embodiments in which a W-way cache is used (e.g., W 4 ways), replacements are done over multiple cycles, with the cache array returning at most W candidates per cycle. Therefore, a narrow pipeline can be used for demotions (e.g., using logic that can check W=4 candidates per cycle). In some embodiments using wider caches (e.g., a 16-way set-associative cache), the controller 310 implements demotion checks over multiple cycles.

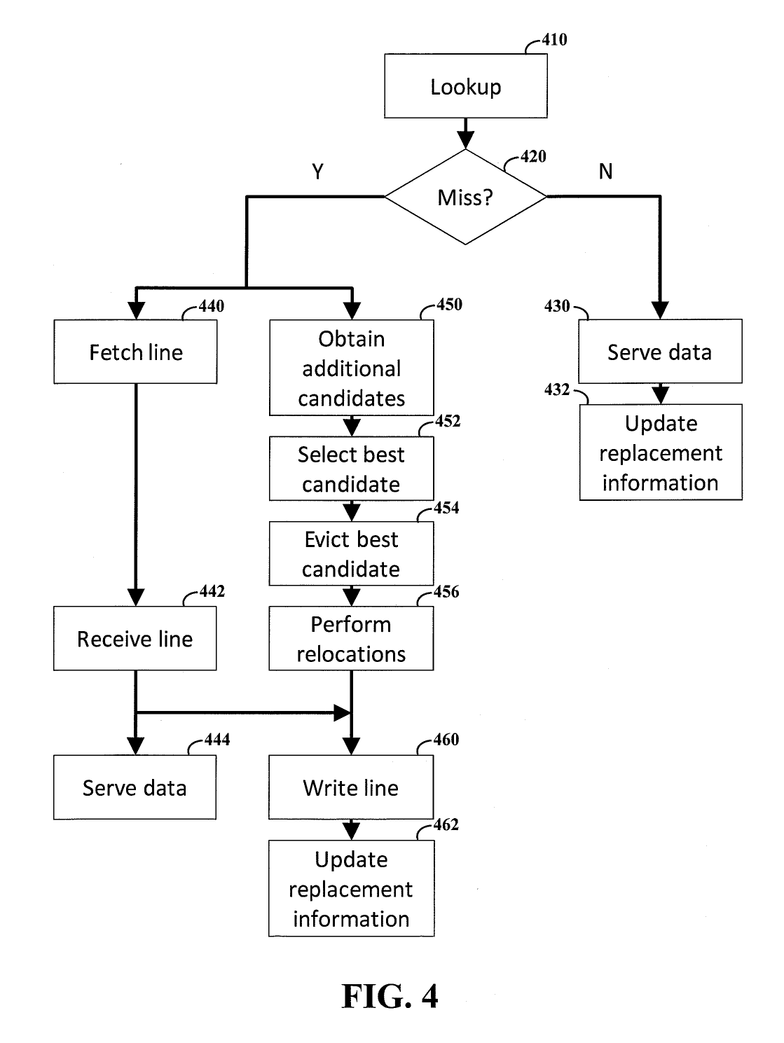

Cache accesses may be carried out in accordance with a variety of approaches. FIG. 4 shows an embodiment for carrying out such cache access. At block 410, a data lookup is carried out and, if no miss occurs at 420 (i.e., a hit), the data is served at 430 and replacement information is updated at 432 (e.g., as discussed above). In the event of a miss at 420, a data fetch and candidate replacement are carried out in parallel as follows. A line is fetched at block 440 and the line is received at block 442. Meanwhile, additional candidates for replacement are obtained at block 450, the best candidate is selected at block 452 and evicted at block 454, with relocation(s) being performed at block 456 (e.g., as shown in FIGS. 2A-2G). These replacement steps may, for example, be carried out in a number of cycles less than that used to fetch the new line, as discussed herein.

The received line is both served at 444 (e.g., per the request upon which the lookup is made at 410), and written at block 460, to a target position vacated via eviction at block 454 (or, e.g., at another location from which data is moved to space created via the eviction). Replacement information is then updated at block 462.

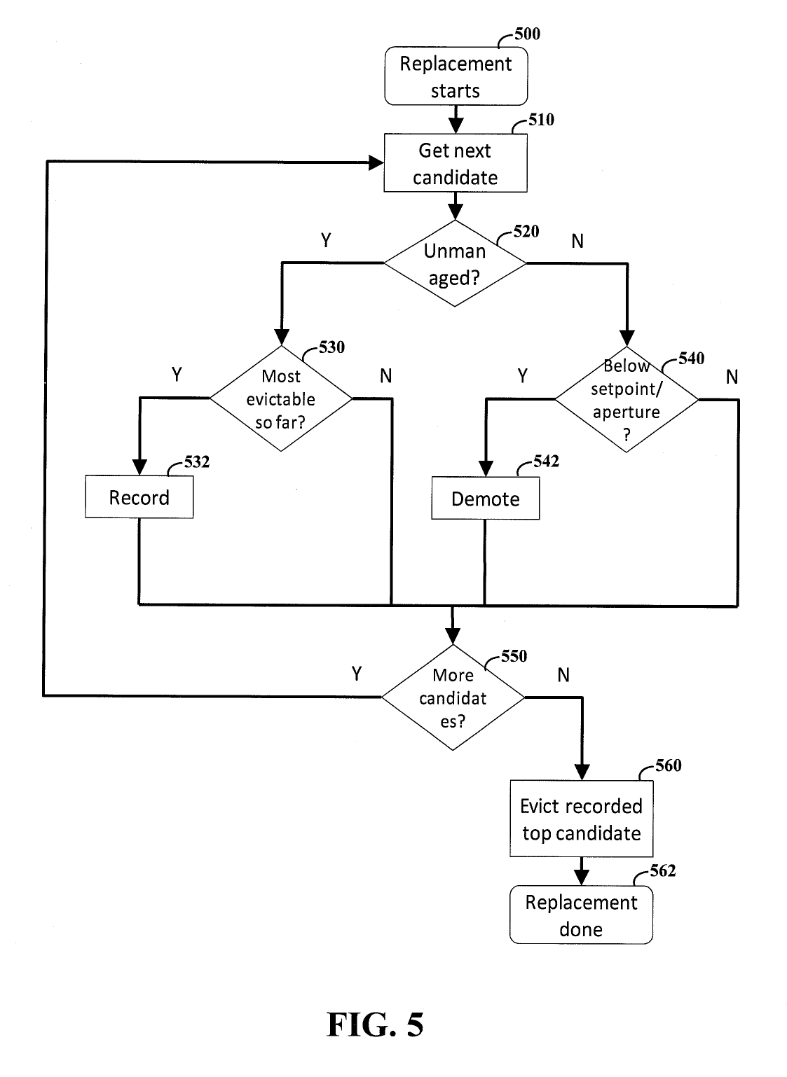

FIG. 5 shows a data flow diagram for demoting data using managed/partitioned and unmanaged/un-partitioned space, in accordance with another example embodiment. A replacement process starts at block 500, with a next replacement candidate being obtained at block 510. If the replacement candidate is located in un-partitioned space at block 520 and is a most evictable candidate in a current process (e.g., is the least recently used candidate) at block 530, the candidate is recorded at block 532. If the candidate identified at block 510 is not from un-partitioned space and space is below a setpoint/aperture in block 540 as discussed above, the candidate is demoted to un-partitioned space at block 542.

The process continues at block 550, at which if there are additional candidates, the next candidate is obtained at block 510, from which the process again continues. If no additional candidates are present at block 550, the top recorded candidate (recorded at block 532) is evicted at block 560, and the replacement process ends at block 562.

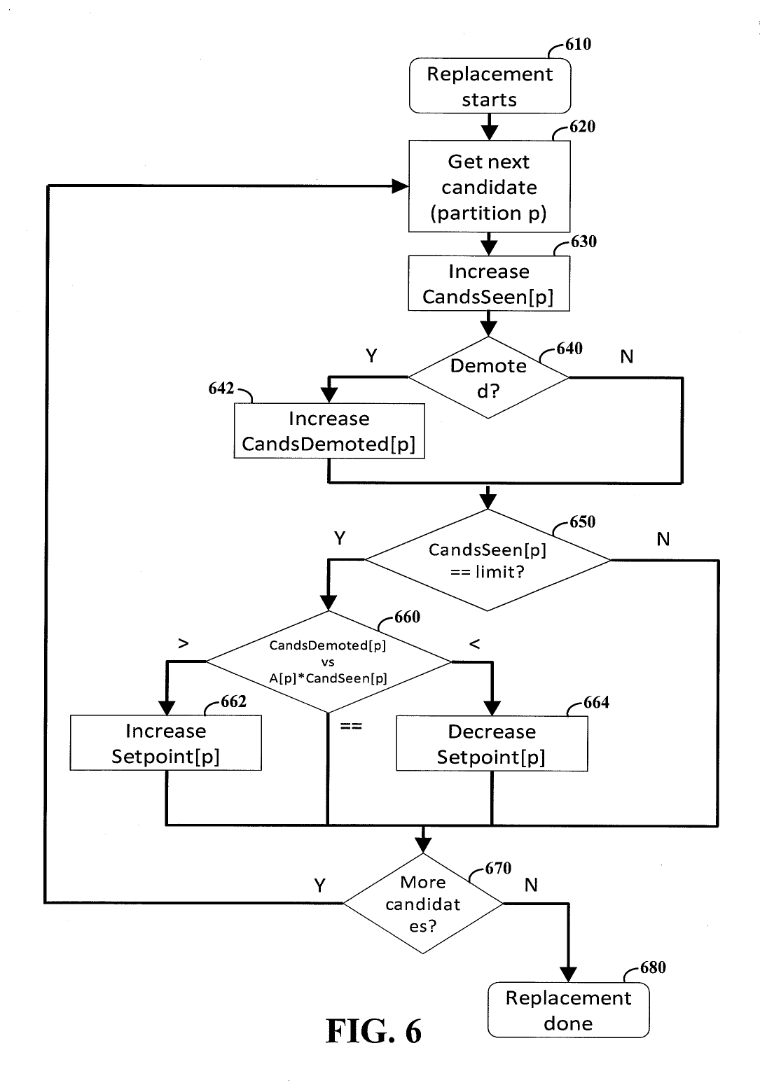

FIG. 6 shows a data flow diagram for setting a set point for determining the demotion of data, in accordance with another example embodiment. At block 610, a replacement process begins, a next candidate (partition p) is obtained at block 620, and the CandsSeen(p) value (representing a number of candidates seen) is increased at block 630. If the candidate is demoted at 640, the CandsDemoted value (indicating a number of candidates demoted) is increased at 642.

If the number of candidates seen has reached a threshold limit at block 650, the number of candidates demoted is compared against the product of the aperture and number of candidates seen at block 660, with the set point being increased at 662 when the former is greater, decreased at 664 when the former is less, and being otherwise unchanged. After this comparison, or if the number of candidates has not reached a threshold at block 650, the process continues at 670. If additional candidates are present at block 670, a next candidate is obtained at block 620 and the replacement process further continues. If additional candidates are not present at block 670, the replacement process terminates at block 680.

The various embodiments as discussed herein may be implemented using a variety of structures and related operations/functions. For instance, one or more embodiments as described herein may be computer-implemented or computer-assisted, as by being coded as software within a coding system as memory-based codes or instructions executed by a computer processor, microprocessor, PC or mainframe computer. Such computer-based implementations are implemented using one or more programmable circuits that include at least one computer-processor and internal/external memory and/or registers for data retention and access. One or more embodiments may also be implemented in various other forms of hardware such as a state machine, programmed into a circuit such as a field-programmable gate array, implemented using electronic circuits such as digital or analog circuits. In addition, various embodiments may be implemented using a tangible storage medium that stores instructions that, when executed by a processor, performs one or more of the steps, methods or processes described herein. These applications and embodiments may also be used in combination; for instance certain functions can be implemented using discrete logic (e.g., a digital circuit) that generates an output that is provided as an input to a processor.

While the present disclosure (with the incorporated underlying provisional patent document) is amenable to various modifications and alternative forms, specifics thereof have been shown by way of example in the drawings and will be described in further detail. It should be understood that the intention is not to limit the disclosure to the particular embodiments and/or applications described. Various embodiments described above and shown in the figures and underlying provisional patent document may be implemented together and/or in other manners. One or more of the items depicted in the drawings/figures, underlying provisional patent document and references cited therein can also be implemented in a more separated or integrated manner, as is useful in accordance with particular applications.

What is claimed is:

1. An apparatus comprising:
a memory circuit configured and arranged with cache lines that store data blocks; and
a controller circuit configured and arranged to control cache-access to the data blocks in the memory circuit by, in response to a cache miss for a data block having an associated address on a memory access path,
fetching data for storage in the memory circuit while executing additional lookups on the memory access path to identify a plurality of candidate locations to store data,
moving an existing set of data from a target location in the cache to one of the plurality of candidate locations and associating the address of the one of the plurality of candidate locations with the existing set of data, the one of the plurality of candidate locations corresponding to one of a subset of locations that are accessible via a single lookup, and
storing the fetched data in the target location and associating the address of the target location with the fetched data.

2. The apparatus of claim 1, wherein the controller circuit is configured and arranged to
execute a lookup function that generates an output identifying the subset of the candidate locations, and
move the existing set of data to one of the subset locations by moving the data to one of the locations identified in the generated output.

3. The apparatus of claim 1, wherein
the memory circuit includes
a partitioned memory circuit region including isolated logical partitions with sizes specified in cache lines, and
an un-partitioned memory circuit region configured and arranged to facilitate data replacement in the isolated partitions, and
the controller circuit is configured and arranged to
increase the size of the isolated partitions by converting space in the un-partitioned memory circuit region to additional isolated partition space, and
decreasing the size of the isolated partitions by converting space in the partitioned memory circuit region to space in the un-partitioned memory circuit region via demoting data in the portioned memory circuit region to the un-partitioned memory circuit region.

4. The apparatus of claim 3, wherein the controller circuit is configured and arranged to define demotion rates for demoting data from each partition to the un-partitioned memory circuit region, based upon a rate at which data is inserted into the partition.

5. The apparatus of claim 4, wherein the controller circuit is configured and arranged to
increase the demotion rate of one of the isolated partitions in response to the insertion rate for the partition exceeding a predefined threshold insertion rate, and
decrease the demotion rate of at least one of the isolated partitions in response to the insertion rate for the partition falling below a predefined threshold.

6. The apparatus of claim 3, wherein the controller circuit is configured and arranged to
maintain a demotion rate of one of the isolated partitions in response to determining that the fetched data will increase the amount of data in the isolated partition to a size that is within a threshold value over a target size of the isolated partition, thereby allowing the one of the isolated partitions to grow over the target size, and
demote data from the one of the isolated partitions by setting a demotion threshold that causes lines of the partitions to be demoted faster to the un-partitioned region, in response to determining that the fetched data will increase the amount of data in the isolated partition to a size that is greater than a threshold value over the target size.

7. The apparatus of claim 3, wherein the controller circuit is configured and arranged to increase and decrease the size of the isolated partitions in response to feedback indicative of a condition of the memory circuit.

8. The apparatus of claim 3, wherein the controller circuit is configured and arranged to demote data from the isolated partitions based upon usage history data for the data in the isolated partitions.

9. The apparatus of claim 3, wherein the controller circuit is configured and arranged to demote data from the isolated partitions to the un-partitioned memory region based upon a number of candidates accessed for demotion and a lookup table storing a threshold values for different partition sizes.

10. The apparatus of claim 1, wherein the controller circuit is configured and arranged to store directory sharer tag data for processors sharing access to memory blocks using a variable number of directory tags by
for cache lines accessed by less than a threshold number of processors, using a single directory tag that associates each cache line address with the processor or processors that use the cache line, and
for each cache line used by a number of processors that is equal to or greater than the threshold number of processors, using at least two directory tags for each cache line.

11. The apparatus of claim 10, wherein defining at least two directory tags includes defining an additional directory tag, in response to at least one existing directory tag being assigned to a threshold number of processors, thereby limiting the size of the tags as additional processors that access the memory circuit are added.

12. The apparatus of claim 1, wherein the controller circuit is configured and arranged to control cache-access to the data blocks in the memory circuit by, for cache hits, returning data blocks corresponding to each hit in response to a single lookup for an associated address on the memory access path.

13. The apparatus of claim 1, wherein the controller circuit is configured and arranged to evict data from the one of the plurality of candidate locations, prior to moving the existing set of data from the target location to the one of the plurality of candidate locations.

14. The apparatus of claim 1, wherein the controller circuit is configured and arranged to
assign usage history data to the fetched data and to store the usage history data as part of the fetched data, in the target location, and
demote data from one of the plurality of candidate locations based upon the usage history data, prior to moving the existing set of data from the target location to one of the plurality of candidate locations.

15. A method for accessing data blocks having an associated address identifying a cache line in a memory circuit, the method comprising:
in response to a cache miss for a data block having an associated address on a memory access path, fetching data for storage in the memory circuit while executing additional lookups on the memory access path to identify a plurality of candidate locations to store data,
moving an existing set of data from a target location in the cache to one of the plurality of candidate locations and associating the address of the one of the plurality of candidate locations with the existing set of data, the one of the plurality of candidate locations corresponding to one of a subset of locations that are accessible via a single lookup, and
storing the fetched data in the target location and associating the address of the target location with the fetched data.

16. The method of claim 15, further including
partitioning the memory circuit into a partitioned region having isolated partitions with sizes specified in cache lines, and an un-partitioned region,
increasing the size of isolated partitions in the memory circuit by converting space in the un-partitioned region to additional isolated partition space, and
decreasing the size of the isolated partitions by converting memory space in the partitioned region to memory space in the un-partitioned region.

17. The method of claim 15, further including
logically assigning storage space in the memory circuit to form a plurality of cache arrays including a plurality of isolated partitions with sizes specified by a number of cache lines, and an un-partitioned memory circuit region,
defining demotion rates for demoting data from each partition based upon an insertion rate for inserting data into the partition and a size of the partitions, and
in response to the demotion rate for a partition exceeding a predefined threshold demotion rate, increasing the size of the partition by converting a portion of the un-partitioned memory circuit region to additional isolated partition space for the partition.

18. The method of claim 17, further including, in response to the demotion rate for a partition falling below a predefined threshold, decreasing the size of the partition by converting space in the partition to space in the un-partitioned memory circuit region.

19. The method of claim 15, wherein moving an existing set of data includes executing a lookup function to generate an output identifying the subset of locations, further including, in response to a cache hit, returning a data block corresponding to the cache hit using a single execution of the lookup function to identify the subset of locations for an associated address on a memory access path specifying the cache line in which the data block is stored.

20. The method of claim 15, further including
for cache lines accessed less than a threshold number of processors, defining a single directory tag that associates each cache line with the processor or processors that access the cache line, and
for each cache line accessed by a number of processors that is equal to or greater than the threshold number of processors, defining at least two directory tags for each cache line, each of the at least two directory tags associating the cache line with at least one of the processors that access the cache line.
